(19) United States
(12) Patent Application Publication
(10) Pub. No.: US 2018/0066602 A1
(43) Pub. Date: Mar. 8, 2018

(54) ENGINE HAVING SHEARING RESISTANCE REDUCTION PATTERNS

(71) Applicant: Hyundai Motor Company, Seoul (KR)

(72) Inventors: Jun-Sik PARK, Ulsan (KR); Sun-Joon MIN, Ulsan (KR); Hee-Gone KIM, Ulsan (KR); Nam-Doo LEE, Ulsan (KR); Ho-Hwan KIM, Busan (KR); Tae-Kyun AN, Ulsan (KR); Seung-Yeop LEE, Hanam-si (KR); Do-Hyung KIM, Ulsan (KR); Tae-Won LEE, lncheon (KR)

(73) Assignee: Hyundai Motor Company, Seoul (KR)

(21) Appl. No.: 15/379,232

(22) Filed: Dec. 14, 2016

(30) Foreign Application Priority Data
Sep. 8, 2016 (KR) 10-2016-0115483

(51) Int. Cl. F02F 1/20

(52) U.S. Cl. CPC F02F 1/20

(57) ABSTRACT

An engine may include a cylinder bore configured to have a combustion chamber formed by setting a top section in which a top dead center is formed, a bottom section in which a bottom dead center is formed, and a middle section H formed between the top section and the bottom section and reduce a shearing resistance by a texturing pattern formed in the middle section H.

### CROSS-REFERENCE(S) TO RELATED APPLICATIONS

The present application claims priority to Korean Patent Application No. 10-2016-0115483, filed Sep. 8, 2016, the entire contents of which is incorporated herein for all purposes by this reference.

### BACKGROUND OF THE INVENTION

### Field of the Invention

Exemplary embodiments of the present invention relate to an engine, and more particularly, to an engine with improved fuel efficiency by shearing resistance reduction patterns formed on an inner surface of a cylinder bore.

### Description of Related Art

Recently, an engine has coped with strengthened laws and fuel efficiency regulations at home and abroad by reducing a contact area between a cylinder bore and a piston based on Newton's law of viscosity to reduce a loss caused by a shearing resistance (friction force).

A cylinder bore and a piston are portions that are first ignited and cause friction within the engine. Here, a piston ring attached to the piston vertically reciprocating depending on a stroke cycle (for example, four strokes) contacts an inside of the cylinder bore to cause friction, causing a loss due to a shearing resistance (friction force). The loss is directly connected with fuel efficiency and therefore causes a reduction in efficiency of the engine.

At present, a laser method and a fly cutting method that machine a top section of the cylinder bore are a representative method for reducing a contact area of the cylinder bore and the piston.

The laser method is a method of performing rough honing machining and semi-finishing honing machining on a cylinder bore, forming a plurality of grooves on an inside surface of the cylinder bore along an internal surface of a top section of the cylinder bore by a laser machining, and then again performing finishing honing machining on the cylinder bore and the fly cutting method is a method of performing honing machining on a cylinder bore and forming a plurality of grooves on an inside surface of the cylinder bore along an internal surface of a top section of the cylinder bore by small tool machining.

However, the laser method and the fly cutting method take excessive machining time to form the groove and therefore are very hard to adjust productivity in mass production.

Above all, the laser method and the fly cutting method has a problem in that the machining portion of the groove is limited to the top section in the entire section of the cylinder bore to make the effect of reducing the loss due to the shearing resistance (friction force) very small.

The reason is that a fluid lubrication section forms a largest section in a driving zone while the middle section in the entire section of the cylinder bore based on a Stribeck curve is formed at the fastest speed, as can be appreciated from the Stribeck curve that is an index of a change in friction coefficient depending on a speed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an engine having shearing resistance reduction patterns capable of greatly increasing a contribution rate of improvement in fuel efficiency based on a Stribeck curve by maximally reducing a contact area by machining a texturing pattern having an optimized pattern shape and a pattern density in a contact section between a cylinder bore and a piston, in particular, maximally reducing a shearing resistance (friction force) loss using a middle section of a cylinder bore.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an exemplary embodiment of the present invention, an engine includes: a cylinder bore configured to have a combustion chamber formed therein by setting a top section in which a top dead center is formed, a bottom section in which a bottom dead center is formed, and a middle section H formed between the top section and the bottom section; a texturing pattern formed in the middle section by using an internal surface of the cylinder bore to reduce a shearing resistance of the cylinder bore; and a liner forming the cylinder bore, having an oil pocket dug therein, the oil pocket being exposed to the cylinder bore and filled with oil, and forming a cylinder block.

When the top section, the middle section, and the bottom section are set to be the entire height, the middle section may be 50 to 54% with respect to 100% of the entire height. The texturing pattern may form a pattern density that is equal to or less than 50% with respect to an area of the middle section.

The texturing pattern may be formed of a texturing groove having a diameter formed of one of a circle, an oval, a hexagon, and a square and a depth considering an oil retention volume and the texturing groove may be formed of a group forming a pattern layout in which a horizontal diamond shape or a vertical diamond shape are repeated.

The size of the diameter may be smaller than a width of the piston ring coupled to the vertically reciprocating piston in the cylinder bore and may be larger than the thickness of the oil film formed on the internal surface of the cylinder bore.

The diamond shape may have the horizontal diamond shape or the vertical diamond shape in which the texturing groove is repeated forming four first, second, third, and fourth texturing grooves in a pair and a pitch between the first and second texturing grooves arrayed in a column and a pitch between the third and fourth texturing grooves arrayed in a row are different from each other.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration diagram of an engine in which shearing resistance reduction patterns according to an exemplary embodiment of the present invention are implemented in a texturing pattern.

FIG. 2 is a diagram illustrating an example of an optimized bore layout for a texturing pattern according to an exemplary embodiment of the present invention.

FIG. 3 is a diagram illustrating an example of a Stribeck curve applied to optimize a bore layout according to an exemplary embodiment of the present invention.

FIG. 4 is a diagram illustrating an example of a pattern layout in which the texturing pattern according to the exemplary embodiment of the present invention is optimized.

FIG. 5 is a diagram illustrating an example in which the pattern layout of the texturing pattern according to the exemplary embodiment of the present invention is changed.

FIG. 6 is a diagram illustrating an example in which a diameter of a texturing groove formed in the texturing pattern according to the exemplary embodiment of the present invention is optimized.

FIG. 7 is a diagram illustrating an example in which a shape of the texturing groove formed in the texturing pattern according to the exemplary embodiment of the present invention is changed.

FIG. 8 is a diagram illustrating an example in which a depth of the texturing groove formed in the texturing pattern according to the exemplary embodiment of the present invention is optimized.

FIG. 9 is a comparison diagram of shearing resistance reduction performance depending on various texturing patterns according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

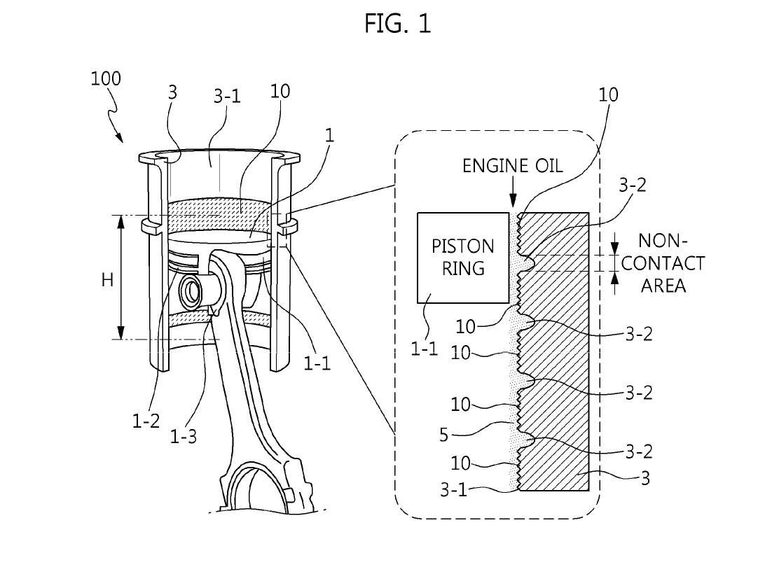

Referring to FIG. 1, an engine 100 includes a piston 1 generating an output with a vertically reciprocating stroke upon combustion, a liner 3 formed with a cylinder bore 3-1 forming a contact surface to the piston 1, and a texturing pattern 10 reducing a shearing resistance of the contact surface with shearing resistance reduction patterns formed in a middle section H of the cylinder bore 3-1, in which the cylinder bore 3-1 forms a combustion chamber and the liner 3 forms a cylinder block.

In detail, the piston 1 is coupled to a piston ring that is divided into a top ring 1-1, a middle ring 1-2, and a bottom ring 1-3, in which the piston rings 1-1, 1-2, and 1-3 form the contact surface to an internal surface of the cylinder bore 3-1. A plurality of oil pockets 3-2 formed by digging the liner 3 at a predetermined depth and a predetermined interval is exposed from the internal surface of the cylinder bore 3-1 to form a non-contact surface between the piston 1 and the cylinder bore 3-1 and an oil film 5 is formed to coat the contact surface between he piston 1 and the cylinder bore 3-1 with oil simultaneously filling the oil pocket 3-2 with oil.

In detail, the texturing pattern 10 is formed of a group of texturing grooves 10-1 forming a specific array formed by digging the liner 3 at a specific depth and interval in the middle section H of the cylinder bore 3-1. A size, a depth, and an interval of the texturing groove 10-1 are smaller than those of the oil pocket 3-2. The texturing pattern 10 may be machined by various machining methods including a laser method and a fly cutting method.

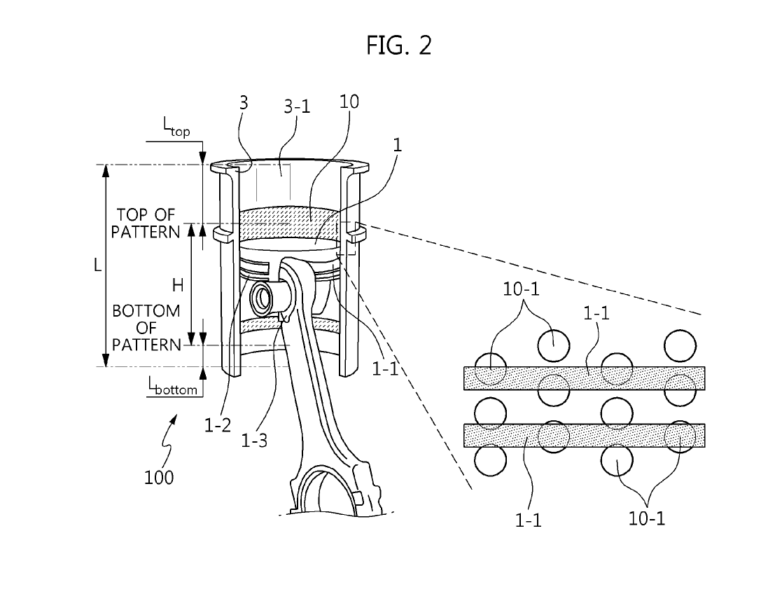

Referring to a bore layout applied to the cylinder bore 3-1 of FIG. 2, the bore layout divides an entire height L of the cylinder bore 3-1 into a top section Lₜₒₚ in which a top dead center of the piston 1 is formed and a bottom section L_{bottom} in which a bottom dead center thereof is formed, in which a section between the top section Lₜₒₚ and the bottom section L_{bottom} is set to be the middle section H. Here, the entire section L means a stroke length at which the piston 1 reciprocates vertically upon combustion. when the entire height L is set to be 100%, the middle section H may be formed at 50 to 54%, the top section Lₜₒₚ may be formed at 18 to 20%, and the bottom section L_{bottom} may be formed at 28 to 30%.

The middle section H forms the texturing pattern 10, the texturing pattern 10 is formed of the texturing grooves 10-1 forming the group, and the texturing groove 10-1 is divided into the top ring 1-1, the middle ring 1-2, and the bottom ring 1-3 to form the non-contact surface where the piston ring coupled to the piston 1 does not contact the internal surface of the cylinder bore 3-1. Further, the texturing groove 10-1 forms a space filled with oil forming the oil film 5. When an area of the middle section H is set to be 100%, a pattern density formed by the group of texturing grooves 10-1 does not exceed 50%. Further, the section in which a row array of the texturing grooves 10-1 always overlaps the piston ring may be greatly formed.

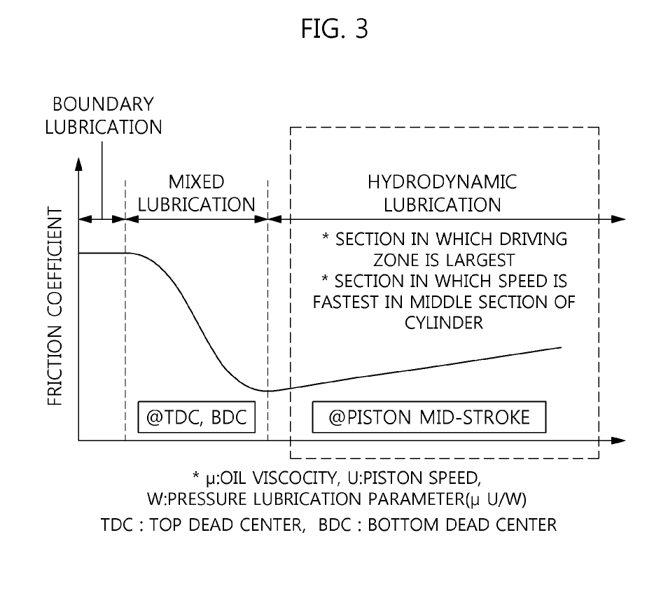

Referring to FIG. 3, it may be appreciated that the optimization ground of the bore layout proves by a Stribeck curve that represents a change in friction coefficient depending on a speed. As illustrated, the Stribeck curve represents that in a driving zone of the engine, the largest section is a fluid lubrication section and the fastest speed is generated in the middle section. Therefore, when in the entire height of the cylinder bore 3-1, the section between the top section Lₜₒₚ in which the top dead center is formed and the bottom section L_{bottom} in which the bottom dead center is formed is set to be the middle section H, the middle section H is the fluid lubrication section and the fastest speed section. As a result, it was experimentally proved that when the texturing pattern 10 is formed in the middle section H rather than in the top section, the optimal effect of reducing the shearing resistance (friction force) is generated.

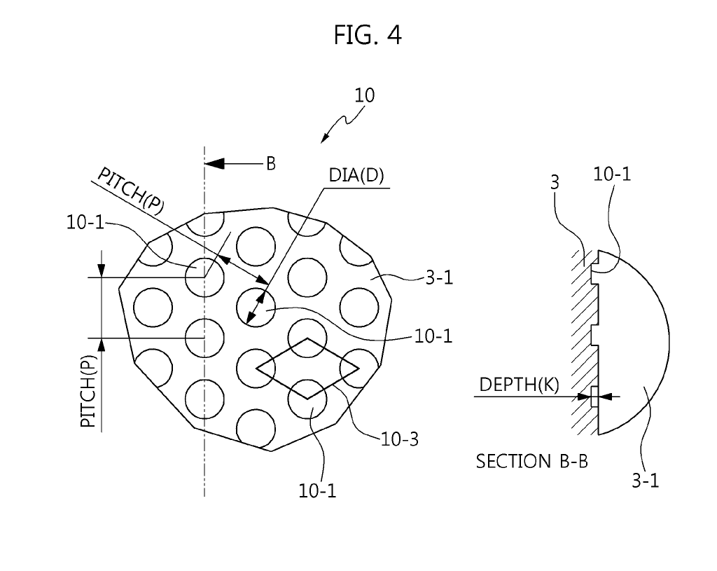

Referring to FIG. 4, the texturing grooves 10-1 applied to the texturing pattern 10 are given a diameter D forming a circle, a depth K dug in the liner 3, and a pitch P forming an interval therebetween, respectively, and has the set pattern density. For example, the diameter may be set to be 0.5 mm, the depth may be set to be 0.002 mm, the pitch may be set to be 0.673 mm, and the pattern density may be set to be equal to or less than 50%. When the pattern density is 50%, the pitch may be set to be 0.173 mm.

Further, the pattern layout applied to the texturing pattern 10 is formed by repeating a horizontal diamond shape 10-3 in which the four texturing grooves 10-1 formed at the interval of the pitch P are formed in a pair. In detail, the four texturing grooves 10-1 is divided into first, second, third, and fourth texturing grooves. Here, two first and second texturing grooves are arrayed in a column and the rest two third and fourth texturing grooves are arrayed in a row, and the interval between the first and second texturing grooves arrayed in a column has one pitch P, while the interval between the thrid and fourth texturing grooves arrayed in a row has two pitches P+P, and thus the horizontal diamond shape 10-3 is formed. as illustrated in FIG. 2, the horizontal diamond shape 10-3 may greatly form the section in which the row array of the texturing groove 10-1 always overlaps with the piston ring.

However, the horizontal diamond shape 10-3 may be variously changed.

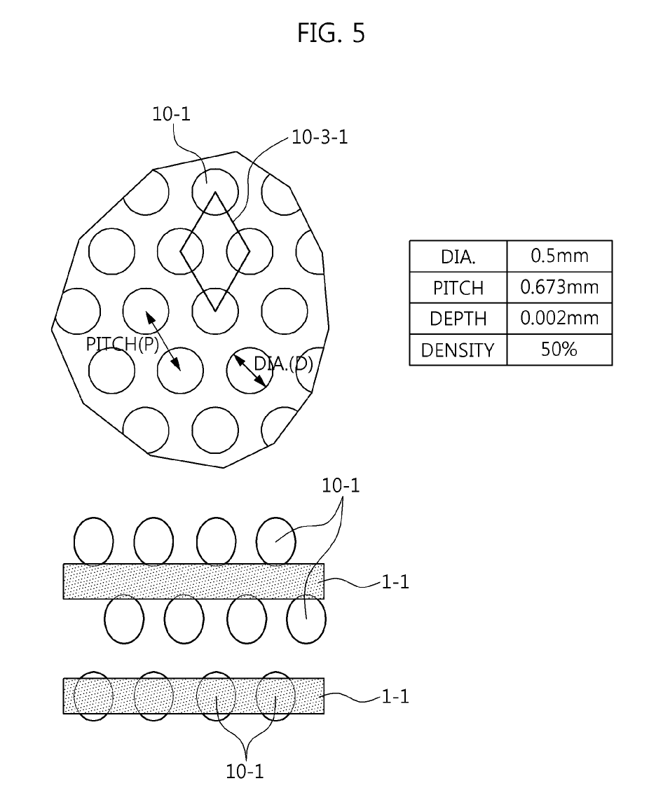

FIG. 5 illustrates an example in which the horizontal diamond shape 10-3 is changed to a vertical diamond shape 10-3-1. As illustrated, the vertical diamond shape 10-3-1 is different only in the position where the four texturing grooves 1 is arrayed and has the same diameter D, depth K, pitch P, and pattern density as the horizontal diamond shape 10-3. In detail, the interval between the two texturing grooves 10-1 arrayed in a column among the four texturing grooves 10-1 has two pitches P+P, while the interval between the two texturing grooves 10-1 arrayed in a row has one pitch P, and thus the vertical diamond shape 10-3-1 is formed. Therefore, the vertical diamond shape 10-3-1 may make the section in which the row array of the texturing groove 10-1 always overlaps with the piston ring slightly smaller than the horizontal diamond shape 10-3.

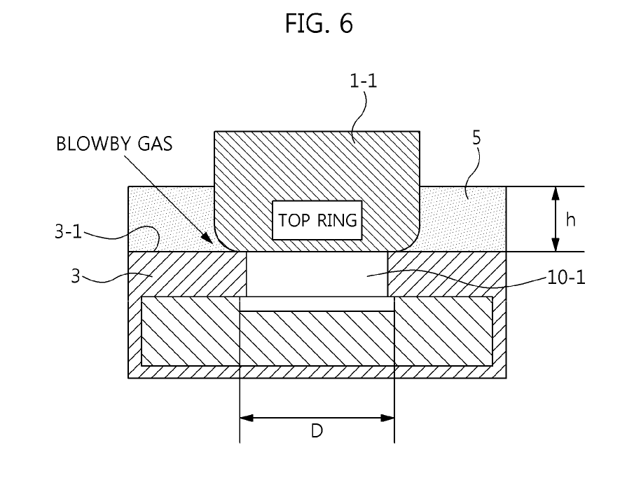

Referring to FIG. 6, it may be appreciated that the diameter D of the texturing groove 10-1 is optimized in consideration of the piston ring and the oil film 5. In detail, the diameter D of the texturing groove 10-1 is smaller than a width of the top ring 1-1, and thus the top ring 1-1 completely covers the texturing groove 10-1 with a width thereof, preventing blowby gas generated at the time of combustion from passing through the texturing groove 10-1. Further, the diameter D of the texturing groove 10-1 is larger than a height h of the oil film 5, guaranteeing the friction reduction effect of the top ring 1-1. For example, when the width of the top ring 1-1 is 1.2 mm and the height h of the oil film 5 is 0.2 mm, the diameter D of the texturing groove 10-1 is optimized as 0.5 mm.

However, the diameter D of the texturing groove 10-1 may be variously changed.

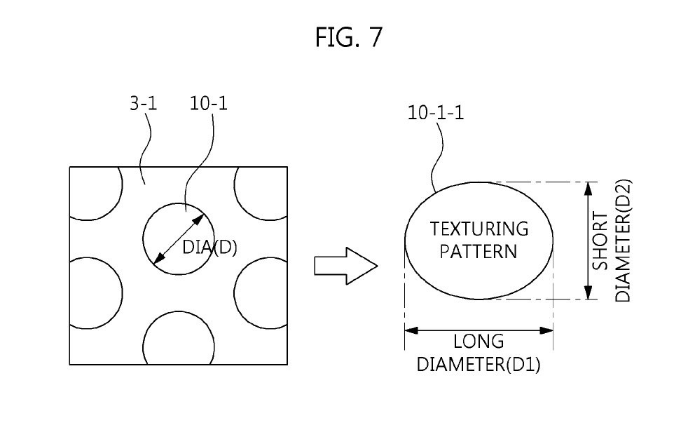

FIG. 7 illustrates an example in which the circular texturing groove 10-1 is changed to the oval texturing groove 10-1-1 having a long diameter D1 and a short diameter D2. The long diameter D1 and the short diameter D2 of the oval texturing grove 10-1-1 are optimized in consideration of the piston ring and the oil film 5, and thus the long diameter D1 is set to be 0.5 mm and the short diameter D2 is set to be larger than 0.3 mm but smaller than 0.5 mm. As a result, the oval texturing groove 10-1-1 may also interrupt the blowby gas and secure the friction reduction effect of the top ring 1-1, like the texturing groove 10-1.

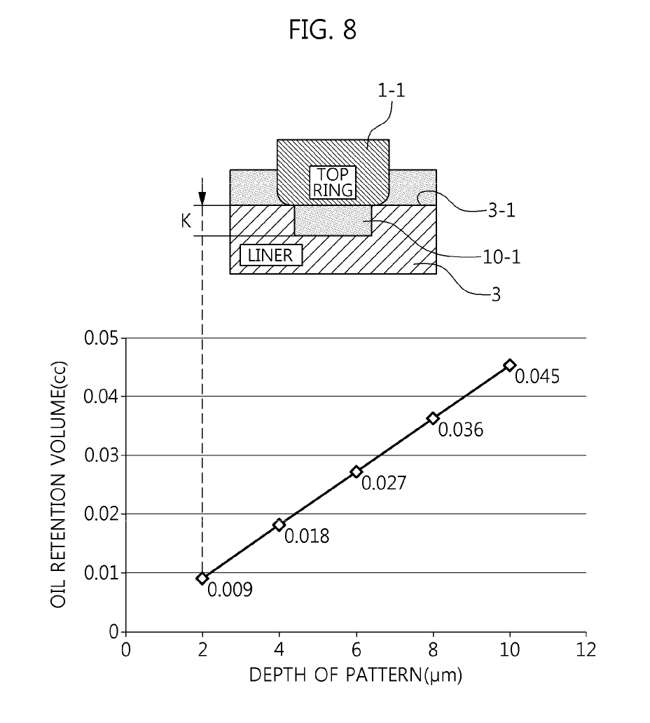

Referring to FIG. 8, it may be appreciated that a depth K of the texturing groove 10-1 is optimized in consideration of an oil retention volume (ORV). In detail, the depth K of the texturing groove 10-1 uses a diagram of ORV (cc)-depth (mm) and the increase in oil consumption in response to the depth K is confirmed from the diagram to apply the depth where the oil consumption is smallest. As a result, the depth K of the texturing groove 10-1 is optimized as 0.002 mm (or 2 μm) in consideration of 0.002 to 0.010 mm (or 2 to 10 μm), minimizing the oil consumption to the shearing resistance reduction.

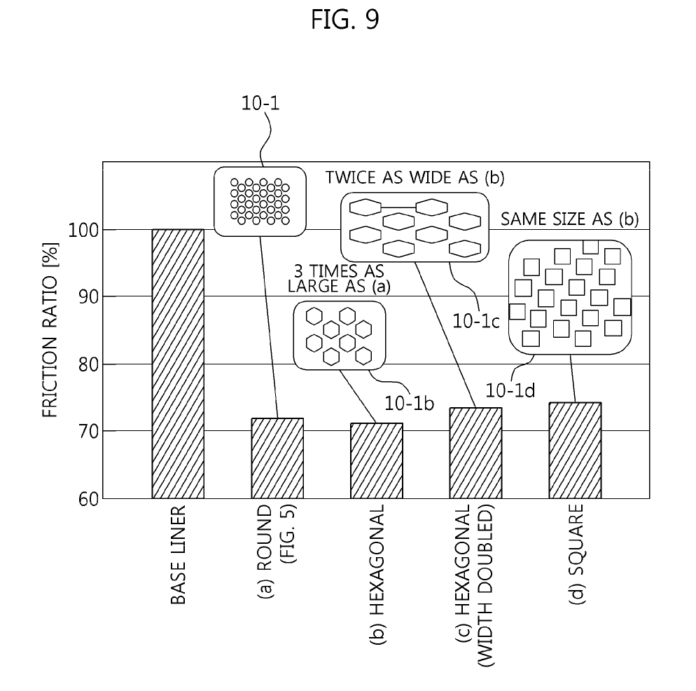

Meanwhile, referring to FIG. 9, it may be appreciated that based on (a) that is the texturing groove 10-1 having a circular structure, the texturing groove may be variously changed to structures including (b) that is a hexagonal texturing groove 10-1b having a hexagonal structure, (c) that is an extended hexagonal texturing groove 10-1c having a hexagonal structure with the increased size, (d) that is a squared, hexagonal texturing groove 10-1d having a squared structure, and the like. Further, as illustrated, it may be appreciated that in each case of (a), (b), (c), and (d), the texturing pattern 10 is applied to the middle section H of the cylinder bore 3-1 to implement similar shearing resistance reduction performance.

According to the engine according to the exemplary embodiment of the present invention as described above, the section between the top section Lₜₒₚ in which the top dead center is formed and the bottom section L_{bottom} in which the bottom dead center is formed is set to be the middle section H and the texturing pattern 10 is machined in the middle section H based on the Stribeck curve to maximize the shearing resistance reduction by the contact surface between the piston 1 and the cylinder bore 3-1 and maximally reduce the loss due to the friction force, greatly increasing the contribution rate of improvement in fuel efficiency.

According to the engine in accordance with the exemplary embodiments of the present invention, it is possible to maximize the reduction ratio of the contact area by greatly reducing the contact area between the piston ring and the cylinder bore by forming the texturing pattern in the middle section of the cylinder bore, as compared with the existing scheme of using a top section of a cylinder bore.

Further, according to the engine in accordance with the exemplary embodiments of the present invention, it is possible to maximize the reduction in loss due to the shearing resistance (friction force) by optimizing the pattern density in addition to maximizing the reduction ratio in the contact area using the middle section of the cylinder bore.

Further, according to the engine in accordance with the exemplary embodiments of the present invention, it is possible to maximize the contribution rate of the improvement in fuel efficiency by the synergy action of the minimum contact area, the optimal pattern, and the minimum loss that are achieved by the texturing pattern formed in the middle section of the cylinder bore.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine, comprising:
a cylinder bore configured to have a combustion chamber formed by setting a top section in which a top dead center is formed, a bottom section in which a bottom dead center is formed, and a middle section formed between the top section and the bottom section,
wherein the cylinder bore is configured to reduce a shearing resistance by a texturing pattern formed in the middle section.

2. The engine of claim 1, wherein when the top section, the middle section, and the bottom section are set to be an entire height, the middle section is 50 to 54% with respect to 100% of the entire height.

3. The engine of claim 1, wherein the texturing pattern is formed of a texturing groove having a diameter and a depth and the texturing groove is formed of a group forming a pattern layout.

4. The engine of claim 3, wherein a size of the diameter is smaller than a width of a piston ring coupled with a piston vertically reciprocating in the cylinder bore and is larger than a thickness of an oil film formed on an internal surface of the cylinder bore.

5. The engine of claim 4, wherein the diameter includes a length to form a circle of the texturing pattern.

6. The engine of claim 4, wherein the diameter includes a length to form an oval of the texturing pattern.

7. The engine of claim 4, wherein the diameter includes a length to form hexagon or a square of the texturing pattern.

8. The engine of claim 3, wherein a size of the depth is determined according to an oil retention volume.

9. The engine of claim 3, wherein the pattern layout is formed by repeating a diamond shape.

10. The engine of claim 9, wherein the diamond shape is repeated by setting four texturing grooves to be a pair.

11. The engine of claim 10, wherein the texturing groove is divided into first and second texturing grooves in which four texturing grooves forming a pair are arranged in a column and third and fourth texturing grooves in which four texturing grooves forming a pair are arranged in a row and a pitch of the first and second texturing grooves is different from that of the third and fourth texturing grooves to form the diamond shape in a horizontal diamond shape or a vertical diamond shape.

12. The engine of claim 3, wherein the texturing pattern forms a pattern density that is equal to or less than 50% with respect to an area of the middle section.

13. The engine of claim 1, wherein the cylinder bore is formed in a liner forming the cylinder block.

14. The engine of claim 13, wherein the liner is provided with an oil pocket dented to be exposed to the cylinder bore.

15. The engine of claim 14, wherein the oil pocket is filled with oil.

16. The engine of claim 15, wherein the oil forms an oil film on an internal surface of the cylinder bore.
